(19) United States
(12) Patent Application Publication
(10) Pub. No.: US 2025/0202547 A1
(43) Pub. Date: Jun. 19, 2025

(54) METHOD AND APPARATUS FOR TRANSMITTING AND RECEIVING SIGNAL USING PARTIAL PRECODING MATRIX INDICATOR(PMI) IN WIRELESS COMMUNICATION SYSTEM

(71) Applicant: SAMSUNG ELECTRONICS CO., LTD., Suwon-si (KR)

(72) Inventors: Huiwon KIM, Suwon-si (KR); Seunghyun LEE, Suwon-si (KR); Sangwon JUNG, Suwon-si (KR)

(21) Appl. No.: 18/984,645

(22) Filed: Dec. 17, 2024

(30) Foreign Application Priority Data
Dec. 19, 2023 (KR) 10-2023-0186084

(51) Int. Cl. H04B 7/0456; H04W 76/27

(52) U.S. Cl. CPC H04B 7/0456; H04W 76/27

(57) ABSTRACT

The present disclosure relates to a 5G communication system or a 6G communication system for supporting higher data rates beyond a 4G communication system such as LTE. A method by a base station comprises: determining a number of first dimensional beam groups and a number of second dimensional beam groups for reporting at least one PMI-related parameter for a plurality of two-dimensional beams; transmitting a RRC configuration message including information about the number of the first dimensional beam groups and the number of the second dimensional beam groups; and receiving reporting of the PMI-related parameter based on the RRC configuration message.

### CROSS-REFERENCE TO RELATED APPLICATION

This application is based on and claims priority under 35 U.S.C. § 119 to Korean Patent Application No. 10-2023-0186084, which was filed in the Korean Intellectual Property Office on Dec. 19, 2023, the entire disclosure of which is incorporated herein by reference.

### BACKGROUND

### 1. Field

The disclosure relates to a signal transmission/reception method and device using a partial precoding matrix indicator (PMI) in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Meanwhile, there is increasing demand for extreme multiple-input and multiple-output (X-MIMO) technology in which the number of antenna ports have been significantly increased by development of wireless communication.

### SUMMARY

The disclosure provides a method and device for transmitting/receiving a signal using a partial precoding matrix indicator (PMI).

The disclosure relates to a method and device for dividing a PMI by group and operating the same to operate a system using a portion of the PMI.

The disclosure provides a method for dividing a PMI candidate group by group and limiting the same and provides a method for operating a system using a partial PMI candidate group.

According to an embodiment, a method by a base station in a wireless communication system comprises determining a number of first dimensional beam groups and a number of second dimensional beam groups for reporting at least one precoding matrix indicator (PMI)-related parameter for a plurality of two-dimensional beams; transmitting, to a user equipment (UE), a radio resource control (RRC) configuration message including information on the number of the first dimensional beam groups and the number of the second dimensional beam groups; and receiving, from the UE, a report of the at least one PMI-related parameter based on the RRC configuration message. A length of a feedback bit string related to a first dimension and a second dimension included in the report of the at least one PMI-related parameter is determined based on the number of the first dimensional beam groups and the number of the second dimensional beam groups.

According to an embodiment, a method by a UE in a wireless communication system comprises receiving, from a base station, a radio resource control (RRC) configuration message including information about a number of first dimensional beam groups and a number of second dimensional beam groups; and transmitting, to the base station, a report of at least one precoding matrix indicator (PMI)-related parameter for a plurality of two-dimensional beams based on the RRC configuration message. A length of a feedback bit string related to a first dimension and a second dimension included in the report of the at least one PMI-related parameter is determined based on the number of the first dimensional beam groups and the number of the second dimensional beam groups.

According to an embodiment, a base station in a wireless communication system comprises a transceiver, and at least one processor. The at least one processor is configured to determine a number of first dimensional beam groups and a number of second dimensional beam groups for reporting at least one precoding matrix indicator (PMI)-related parameter for a plurality of two-dimensional beams, transmit, to a user equipment (UE), a radio resource control (RRC) configuration message including information on the number of the first dimensional beam groups and the number of the second dimensional beam groups, and receive, from the UE, a report of the at least one PMI-related parameter based on the RRC configuration message. A length of a feedback bit string related to a first dimension and a second dimension included in the report of the at least one PMI-related parameter is determine based on the number of the first dimensional beam groups and the number of the second dimensional beam groups.

According to an embodiment, a UE in a wireless communication system comprises a transceiver, and at least one processor. The at least one processor is configured to receive, from a base station, a radio resource control (RRC) configuration message including information on a number of first dimensional beam groups and a number of second dimensional beam groups, and transmit, to the base station, a report of at least one precoding matrix indicator (PMI)-related parameter for a plurality of two-dimensional beams based on the RRC configuration message. A length of a feedback bit string related to a first dimension and a second dimension included in the report of the at least one PMI-related parameter is determine based on the number of the first dimensional beam groups and the number of the second dimensional beam groups.

A method and device according to an embodiment may reduce the RRC overhead of a base station using a method for allocating a PMI candidate group by group.

A method and device according to an embodiment may limit PMI candidate groups for reporting to thereby reduce search complexity of a UE and the number of bits required to feed back a PMI index, decreasing the amount of uplink control information (UCI).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates an example of an FD-MIMO system using multiple transmit antennas according to an embodiment of the present disclosure;

FIG. 2 illustrates an example of a radio resource that may be scheduled on a downlink in a wireless communication system according to an embodiment of the present disclosure;

FIGS. 3A and 3B illustrate an example of a distribution of PMI indices in a wireless communication system according to an embodiment of the present disclosure;

FIGS. 4A, 4B, and 4C illustrate an example of dividing a beam grid by beam group and operating the same according to an embodiment of the present disclosure;

FIG. 5 illustrates an example of feeding back one beam group by beam grouping according to an embodiment of the present disclosure;

FIG. 6 illustrates an example of a beam grid index fed back for one beam group by beam grouping according to an embodiment of the present disclosure;

FIGS. 7A, 7B, and 7C illustrate an example of a beam grid index fed back for one beam group by beam grouping according to an embodiment of the present disclosure;

FIGS. 8A, 8B, and 8C illustrate an example of a beam grid index fed back for one beam group by beam grouping according to an embodiment of the present disclosure;

FIG. 9 illustrates an example of a beam grid index fed back for a plurality of beam groups by beam grouping according to an embodiment of the present disclosure;

FIGS. 10A, 10B, and 10C illustrate an example of a beam grid index fed back for a plurality of beam groups by beam grouping according to an embodiment of the present disclosure;

FIG. 11 illustrates a structure of a base station according to an embodiment of the present disclosure; and

FIG. 12 illustrates a structure of a UE according to an embodiment of the present disclosure.

### DETAILED DESCRIPTION

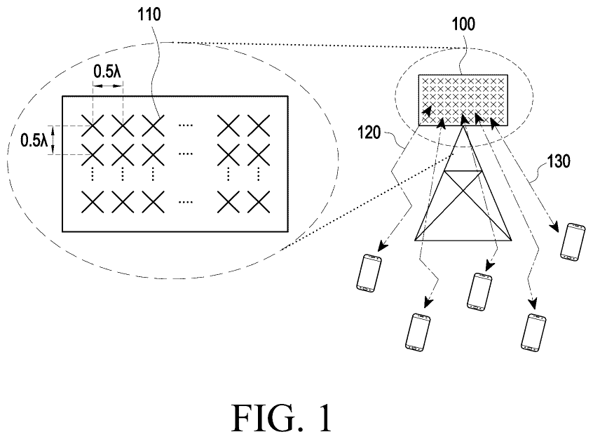

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings. The same reference denotations may be used to refer to the same or similar elements throughout the specification and the drawings. When making the gist of the disclosure unclear, the detailed description of known functions or configurations is skipped.

In describing the embodiments of the disclosure, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card.

According to embodiments of the disclosure, the base station may be an entity allocating resource to terminal and may be at least one of gNode B, gNB, eNode B, eNB, Node B, base station (BS), wireless access unit, base station controller, or node over network. The base station may be a gNB that provides network access to UE(s) through a network of backhaul and access links in an NR system.

Further, the UE may include a user equipment (UE), a mobile station (MS), a cellular phone, a smart phone, a computer, or various devices capable of performing a communication function. In the disclosure, downlink (DL) refers to a wireless transmission path of signal transmitted from the base station to the terminal, and uplink (UL) refers to a wireless transmission path of signal transmitted from the terminal to the base station.

Although the LTE or LTE-A systems may be described below as an example, embodiments of the disclosure may be applied to other communication systems having a similar technical background or channel shape. For example, 5G mobile communication technology (5G, new radio, NR) or 6G developed after LTE-A may be included therein, and 5G or 6G below may be a concept including legacy LTE, LTE-A and other similar services. Further, the embodiments may be modified in such a range as not to significantly depart from the scope of the disclosure under the determination by one of ordinary skill in the art and such modifications may be applicable to other communication systems.

As used herein, terms denoting signals, terms denoting channels, terms denoting control information, terms denoting network entities, and terms denoting device components are provided as an example for ease of description. As used herein, terms for identifying nodes, terms denoting messages, terms denoting inter-network entity interfaces, and terms denoting various pieces of identification information are provided as an example for ease of description. The disclosure is not limited to the terms, and other terms equivalent in technical concept may also be used.

Further, although the disclosure describes various embodiments using terms used in some communication standards (e.g., 3rd generation partnership project (3GPP)), this is merely an example for description. Various embodiments of the disclosure may be easily modified and applied in other communication systems.

FIG. 1 illustrates an example of an FD-MIMO system using multiple transmit antennas according to an embodiment of the present disclosure.

Referring to FIG. 1, the base station 100 transmits wireless signals through a few tens or more transmit antennas. A plurality of transmit antennas 110 are disposed to maintain a minimum distance from each other. As an example, the minimum distance is a half of the wavelength of the wireless signal transmitted. Generally, where the transmit antennas remain spaced at a distance which is a half (0.52) of the wavelength of the wireless signal, the respective signals transmitted from the transmit antennas are influenced by radio channels that are mutually less correlated. Where the band of the wireless signal transmitted is 2 GHz, the minimum distance becomes 7.5 cm, and if the band becomes larger than 2 GHZ, this minimum distance further shortens.

In FIG. 1, a few tens or more transmit antennas arranged in the base station 100 are used to transmit signals 120 and 130 to one or more terminals. Proper precoding may be applied to the plurality of transmit antennas 110 of the base station 100, allowing them to simultaneously transmit signals to the plurality of terminals. At this time, one UE may receive one or more information streams. Generally, the number of information streams receivable by one UE is determined depending on the channel context and the number of receive antennas owned by the UE.

In order to effectively implement the FD-MIMO system, the UE needs to exactly measure the channel context and/or interference magnitude and transmit effective channel status information to the base station using the same. The base station receiving the channel status information determines UEs on which the base station performs transmission, at what data transmission rate to perform transmission, or the precoding to apply using the channel status information in connection with downlink transmission. Since the FD-MIMO system has more transmit antennas than the existing LTE/LTE-A system, applying the channel status information of the existing LTE/LTE-A system (the LTE/LTE-A system may simply be referred to as LTE system unless stated otherwise) to the FD-MIMO system may cause the uplink overhead issue that massive control information may be transmitted on the uplink.

The wireless communication system has limited time, frequency, and power resources. Thus, if more resources are allocated to the reference signal, the resources allocatable for traffic channel (data traffic channel) transmission may be reduced, thus resulting in a decrease on the absolute amount of data transmitted. In such case, the channel measurement and estimation capability may be enhanced, but since the absolute amount of data transmitted is reduced, the overall system capability may be rather lowered. Accordingly, a proper distribution is required between resources for the reference signal and resources for signals for traffic channel transmission in order to bring up with the optimal performance from a point of view of the overall system capability.

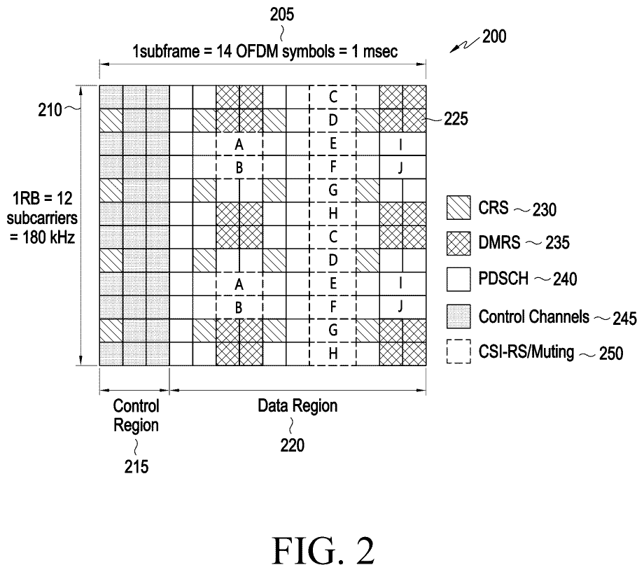

FIG. 2 illustrates an example of a radio resource schedulable on the downlink in an LTE/LTE-A system according to an embodiment of the present disclosure, wherein the minimum unit of the radio resource, i.e., one subframe and one resource block (RB), is shown.

The radio resource shown in FIG. 2 is constituted of one subframe 200 including a control region 215 and a data region 220 on the time axis and one RB on the frequency axis. Such a radio resource includes, e.g., 12 subcarriers 210 in the frequency domain and 14 OFDM symbols 205 in the time domain, totaling 168 unique frequencies and time positions. In the LTE/LTE-A system, each frequency and time position corresponding to one subcarrier and one symbol section is referred to as a resource element (RE) 225.

The LTE system may transmit a plurality of different types of signals in the radio resource shown in FIG. 2 as follows.

Cell specific RS (CRS) 230: a reference signal that is periodically transmitted for all the UEs belonging to one cell and that may be shared by a plurality of UEs.

Demodulation reference signal (DMRS) 235: a reference signal transmitted for a particular UE. This signal is transmitted only when data is transmitted to the corresponding UE. A DMRS may consist of a total of eight DMRS ports. In LTE/LTE-A, port 7 to port 14 correspond to DMRS ports, and the ports maintains orthogonality not to interfere with each other using code division multiplexing (CDM) or frequency division multiplexing (FDM).

Physical downlink shared channel (PDSCH) 240: a data channel transmitted on the downlink, used for a base station to transmit traffic to a UE, and transmitted via an RE where no reference signal is transmitted in the data region of FIG. 2.

Channel status information reference signal (CSI-RS) 250: a reference signal transmitted for UEs belonging to one cell and used to measure the channel status. A plurality of CSI-RSs may be transmitted in one cell.

Other control channels (PHICH, PCFICH, and PDCCH) 245: provide control information necessary for the UE to receive the PDSCH or transmit the ACK/NACK to operate the hybrid automatic repeat and request (HARQ) for uplink data transmission.

Besides the signals, the LTE-A system may set a muting so that CSI-RS transmitted from another base station may be received without interfering with the UEs in the cell. The muting may apply in the position where the CSI-RS may be transmitted. Generally, the UE may skip the corresponding radio resource, where the CSI-RS is transmitted, and may receive a traffic signal. The muting in the LTE-A system is also called zero-power CSI-RS. This is why the muting applies likewise to the resource positions of the CSI-RS and no transmit power is transmitted.

Referring to FIG. 2, the CSI-RS may be transmitted using some of the positions denoted with A, B, C, D, E, E, F, G, H, I, and J depending on the number of antennas transmitting the CSI-RS. Further, the muting may also apply to some of the positions denoted with A, B, C, D, E, E, F, G, H, I, and J. In particular, the CSI-RS may be transmitted via two, four, or eight REs depending on the number of antenna ports. In case the number of antenna ports is two, the CSI-RS is transmitted through a half of a particular pattern of FIG. 2, in case the number of antenna ports is four, the CSI-RS is transmitted through the overall particular pattern, and in case the number of antenna ports is eight, the CSI-RS is transmitted via two patterns. By contrast, the muting is carried out always through each pattern. That is, the muting, although applicable to a plurality of patterns, cannot apply to only part of one pattern in the case where the muting does not overlap the position of the CSI-RS. However, only if the muting overlaps at position the CSI-RS, the muting may apply only to part of one pattern.

Where the CSI-RS is transmitted over two antenna ports, the CSI-RS transmits the respective signals of the antenna ports in two REs connected together on the time axis, and the respective signals of the antenna ports are distinguished by orthogonal codes. Further, where the CSI-RS is transmitted for four antenna ports, two REs are added to the CSI-RS for two antenna ports, so that signals for the two antenna ports are further transmitted by the same method. The same also applies where the CSI-RS is transmitted for eight antenna ports.

Generally, the wireless communication system needs to transmit a reference signal to measure the state of the downlink channel. In the case of the 3GPP long term evolution advanced (LTE-A) system, the UE may measure the channel status between itself and the base station using a CRS or channel status information reference signal (CSI-RS) transmitted from the base station. Basically, some factors may be considered for the channel status, e.g., the quantity of interference on the downlink. The interference quantity on the downlink includes interference signals or thermal noise that is caused by the antennas in the neighbor base station and this is critical for the UE to determine the channel context of the downlink.

As an example, where the base station using one transmit antenna transmits signals to the UE using one receive antenna, the UE determines per-symbol energy receivable on the downlink using the reference signal received from the base station and the amount of interference to be simultaneously received in the period where the symbol is received and determines the signal-to-noise ratio (e.g., Es/Io). The determined Es/Io is converted into a data transmission speed or its corresponding value and is notified to the base station in the form of a CQI, thereby enabling determination as to the data transmission speed at which the base station may perform data transmission to the UE on downlink.

In the LTE-A system, the UE feedbacks information about the channel status of the downlink to the base station so that it may be utilized for downlink scheduling by the base station. That is, the UE measures the reference signal transmitted from the base station on downlink and feedbacks the information extracted therefrom to the base station in a form as defined in the LTE-LTE-A standards. The information fed back by the UE in the LTE/LTE-A system includes three types of information (RI, PMI, and CQI) as follows:
1) Rank indicator (RI): the number of spatial layers that may be received in the current channel status by the UE;
2) Precoder matrix indicator (PMI): an indicator for a precoding matrix favored by the UE in the current channel status; and/or
3) Channel quality indicator (CQI): a maximum data rate at which the UE may perform reception in the current channel status. The CQI may be replaced with the signal-to-noise ratio (SINR), maximum error correction code rate and modulation scheme, or data efficiency per frequency which may be utilized similar to the maximum data rate.

The RI, PMI, and CQI are associated with one another and have meanings. Different precoding matrices as supported in the LTE/LTE-A system are defined per rank as an example. Accordingly, the PMI value Y when the RI is 1 and the PMI value Y when the RI is 2 are interpreted differently, for example. Further, it is assumed that when the terminal determines the CQI, the PMI value, Y, that the terminal has provided to the base station has also applied. That is, the UE feedbacking the RI_X, PMI_Y, and CQI_Z to the base station is the same as the UE notifying the base station that data may be received at the data transmission rate corresponding to the CQI_Z when the rank is the RI_X and the precoding is the PMI_Y. As such, the UE may assume the transmission scheme that the base station is to perform when calculating the CQI so that the optimized performance can be achieved when the base station actually performs transmission in the transmission scheme.

In the structure of type 1 single panel PMI codebook, N ports are determined by N1 indicating the number of ports in the horizontal direction and N2 indicating the number of ports in the vertical direction and, under the assumption of cross polarization, N is defined as N=2×N1×N2. When the oversampling factor in the horizontal direction is defined as O1 and the oversampling factor in the vertical direction is defined as O2, the number of 2-D DFT beam grids to support N ports is defined as N1×O1×N2×O2.

The basic form of the PMI codebook is as shown in Equation 1 below.

$$\begin{matrix}W = {W}_{1} {W}_{2} & ( {W}_{1} = [ \begin{matrix}B & 0 \\ 0 & B\end{matrix} ] , B = {X}_{1} ⊗ {X}_{2} , {W}_{2} = [ \begin{matrix}{e}_{p} \\ {φ}_{n} {e}_{p}\end{matrix} ] )\end{matrix} \qquad [ Equation 1 ]$$

where
eₚ=A vector where the pth row is 1 and the remaining rows are 0s;
W₁: Long-term and/or wideband precoding matrix;
W₂: Short-term and/or subband precoding matrix;

$${X}_{1} : {v}_{l} = {[ 1 {e}^{j \frac{2 π l}{{N}_{1} {O}_{1}}} … {e}^{j \frac{2 π l ( {N}_{1} - 1 )}{{N}_{1} {O}_{1}}} ]}^{T} ;$$

and

$${X}_{2} : {u}_{m} = {[ 1 {e}^{j \frac{2 π m}{{N}_{2} {O}_{2}}} … {e}^{j \frac{2 π m ( {N}_{2} - 1 )}{{N}_{2} {O}_{2}}} ]}^{T} .$$

In standards related to wireless communication systems, N1, N2, O1, and O2 are defined as shown in Table 1 below according to the number of CSI-RS antenna ports.

TABLE 1
Supported configurations of (N₁, N₂)and (O₁, O₂)

| Number of | | |
|---|---|---|
| CSI-RS antenna ports, P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

The base station may receive a PMI report from the UE. As an example, the PMI codebook where RI is 4 is as shown in Equation 2 below, the variables i_{1,1}, i_{1,2}, i_{1,3}, i₂, k₁, and k₂ are used, k₁ and k₂ are previously determined according to N1, N2 and i_{1,3}, and the UE reports i_{1,1}, i_{1,2}, i_{1,3}, and i₂ to the base station through the PMI report.

$${W}_{{i}_{1 , 1} , {i}_{1 , 1} + {k}_{1} , {i}_{1 , 2} , {i}_{1 , 2} + {k}_{2} , {i}_{2}}^{( 4 )} = {W}_{l , {l}^{′} , m , {m}^{′} , n}^{( 4 )} \qquad [ Equation 2 ]$$

Through i_{1,1}, i_{1,2}, i_{1,3}, and i₂ received from the UE, the base station derives l, l′, m, m′, and n. l, l′, m, m′, and n are as follows:
l: Horizontal Antenna (beam selection);
l′: for multi-layer, determined by i_{1,1}, i_{1,3};
m: Vertical Antenna (beam selection);
m′: for multi-layer, determined by i_{1,2}, i_{1,3};
n: ±45° antenna (Co-phasing value); and
determined by i₂.

Referring to Table 1 above, operation of up to 32 channel status information-reference signal (CSI-RS) ports is supported for operating the precoding matrix. However, eXtreme multi-input multi-output (X-MIMO) to be used in next-generation mobile communications is expected to use 256 or more ports. Accordingly, the PMI matrix generated based on 2D-DFT (discrete Fourier transform) has the size of 2D-DFT defined by the defined number of CSI-RS ports and the oversampling factor value.

In the wireless communication system, when N1 or N2 is 1, the value of the oversampling factor is defined as 1, and when the value is larger than 1, it is defined as 4. Accordingly, to support 32 ports, N1×N2×O1×O2=32/2×4×4=256 beam grids are required, but for 256 ports, N1×N2×O1×O2=256/2×4×4=2048 beam grids are required. In other words, in an X-MIMO system, as the number of antenna ports used increases, the number of beam grids operated also increases, which may lead to an increase in the search complexity of the UE and an increase in the number of bits required for the UE to feed back the PMI index.

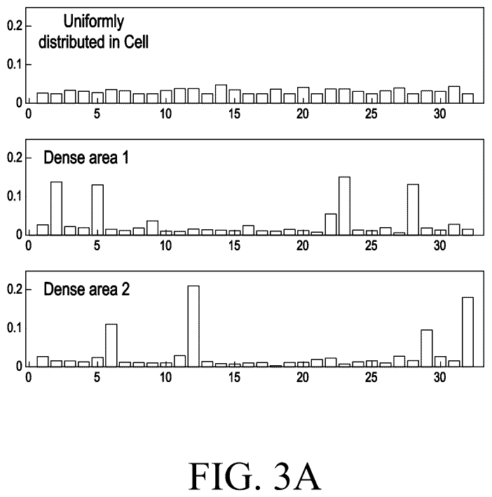

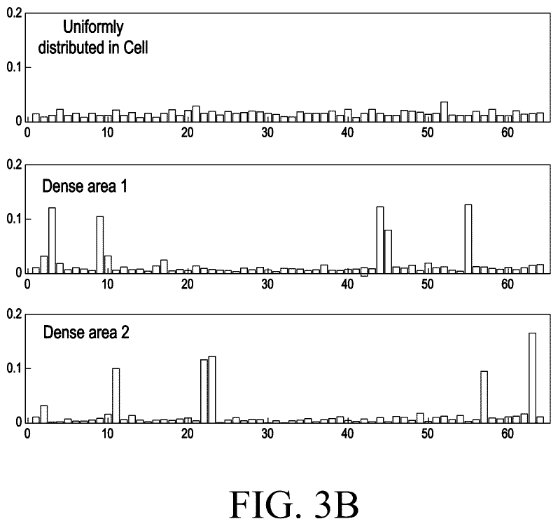

FIGS. 3A and 3B are views illustrating an example of a distribution of precoding matrix indicator (PMI) indices in a wireless communication system according to an embodiment of the present disclosure.

In certain environments, the distribution of PMI indices may be dense, as shown in FIGS. 3A and 3B. FIG. 3A illustrates a distribution of i_{1,1} reported when 32 ports (N1=8, N2-2) are used, and FIG. 3B illustrates a distribution of i_{1,1} reported when 256 ports (N1=16, N2-8). As such, when the PMI distribution is dense, the reported PMI candidate group may be limited and operated. In the wireless communication system, the PMI candidate group (beam index) may be limited on a per-bit basis through the n1-n2-TypeI-SinglePanel-Restriction parameter in the codebookConfig of the radio resource control (RRC) configuration but, when multiple ports are used like X-MIMO, limiting the PMI index on a per-bit basis may cause an increase in overhead.

Described below is an RRC configuration operation for partial PMI according to an embodiment. The base station may identify the PMI log reported for a specific period and accordingly figure out the beam grid area having a high reporting frequency. Based on the above information, the base station may divide the 2D-DFT beam grind into multiple groups and limit beam groups with low reporting frequency, thereby enabling partial operation of PMI.

To divide the beam group, consecutive 2-D DFT beams in the horizontal direction and vertical direction are bundled up into one beam group, and the number of beam groups present in the horizontal direction is defined as K1, and the number of beam groups present in the vertical direction is defined as K2. In other words, one beam grid may be operated, divided into K1×K2 groups.

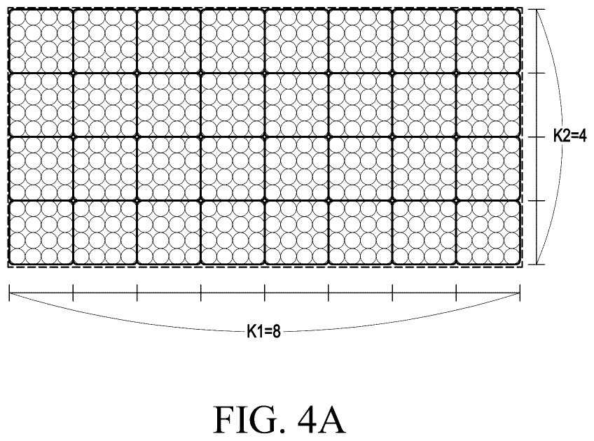

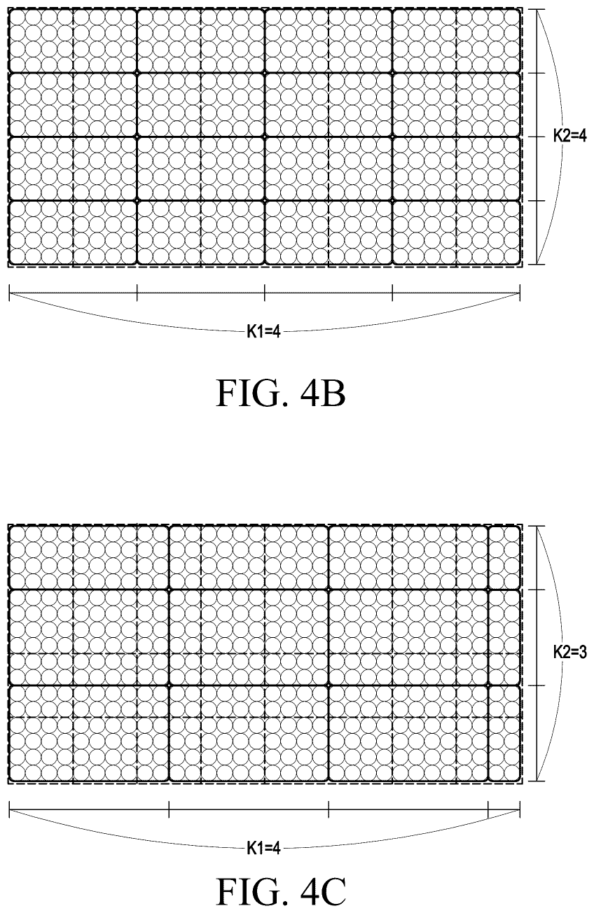

FIGS. 4A, 4B, and 4C illustrate an example of dividing a beam grid by beam group and operating the same according to an embodiment of the present disclosure.

FIG. 4A illustrates a case of generating one beam group by grouping as many beams as the oversampling factor. In this case, beam groups corresponding to N1 and N2 may be generated (K1=N1, K2=N2), and when N1=8, N2=4, O1=4, and O2=4 as shown in FIG. 4A, K1=8, K2=4, i.e., 32 beam groups may be generated.

FIG. 4B illustrates a case of generating one beam group by grouping a number of beams corresponding to a multiple of the oversampling factor. In this case, when constants multiplied by the oversampling factor in each direction are defined as M1 and M2, M1×O1 and M2×O2 beams are grouped and divided into groups, and N1/M1 and N2/M2 beam groups are generated. (K1=N1/M1, K2=N2/M2) As shown in FIG. 4B, when N1=8, N2=4, O1=4, O2=4, M1=2, and M2=1, K1=4, K2=4, i.e., 16 beam groups may be generated.

FIG. 4C illustrates a case of generating one beam group by grouping a number L1 or L2 of beams, where the number is unrelated to the oversampling factor. In this case, a different number of beams may be assigned to the last beam group, and ┌N1×O1/L1┐ ┌N2×O2/L2┐ beam groups may be generated in each direction. As shown in FIG. 4C, when N1=8, N2=4, O1=4, 02=4, L1=10, and L2=6, K1=4, K2=3, i.e., 12 beam groups may be generated.

After the beam groups are divided by the method shown in FIGS. 4A to 4C, the base station may limit the PMI subset through the RRC configuration. In the conventional wireless communication system, the operation of the PMI is limited through the n1-n2-TypeI-SinglePanel-Restriction field present in the CodebookConfig field in the RRC, and one PMI matrix is matched to one bit through N1×O1×N2×O2 bit strings so that it is limited to a value of 0 or 1. As an embodiment, a field in which n1=N1 and n2=N2 may be used in the parameter for the beam grid in the n1-n2-TypeI-SinglePanel-Restriction field.

In the disclosure, fields n1-GroupSize and n2-GroupSize defining K1 and K2 which are the numbers of beam groups may be included in the CodebookConfig field. Each field requires ┌log₂ K1┐, ┌log₂ K2┐ additional bits. If the n1-GroupSize and n2-GroupSize fields are active, the base station may limit the PMI matrix on a per-beam group basis, and if the n1-GroupSize and n2-GroupSize fields are not active, the base station may limit the PMI matrix according to the conventional method. If the PMI matrix is limited on a per-beam group basis, the beams may be limited to K1×K2 beam strings, thereby reducing overhead generated to limit the beams. For example, in a system using N1=2, N2=2, O1=4, and O2=4, the conventional method controls beams by 64 bits string but, beams may be controlled by (K1=2, K2=2) 4 bits string through beam group operation.

Hereinafter, a method for operating a system using a partial PMI is described. Operating a system using a partial PMI includes using only a PMI matrix corresponding to one beam group in system operation and using only a PMI matrix corresponding to two or more beam groups in system operation.

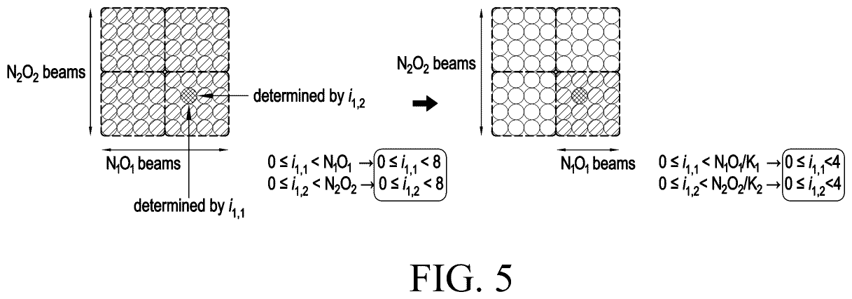

First, in FIGS. 5 to 9, a UE reporting method for a case in which only a PMI matrix corresponding to one beam group is used for system operation is described.

FIG. 5 illustrates an example of feeding back one beam group by beam grouping according to an embodiment of the present disclosure.

Referring to (a) and (b) of FIG. 5, UE reporting methods are compared and described between when all PMIs are reported and when only a PMI matrix corresponding to one beam group is used for system operation.

In the wireless mobile communication system, all PMI indices in the 2-D DFT beam grid are taken as candidates, and the operation of a specific PMI matrix may be limited through RRC, but all indices of the entire 2-DFT beam grid may be able to be expressed while the UE reports the index. In other words, referring to FIG. 5(a), even if the operation of the PMI matrix is limited through n1-n2-TypeI-SinglePanel-Restriction, the amount of UCI to be reported by the UE does not change, and the number of feedback bits generated to report the PMI index is the same as Dog: ┌N1×O1×N2×O2┐.

A method of limiting a PMI by grouping a 2D-DFT beam grid, which is a method provided in the disclosure, may reduce the range of indices to be expressed as the number of reportable beams decreases.

Referring to FIG. 5(b), the number of feedback bits is variably changed according to K1 and K2, and the number of feedback bits required to report the PMI index is the same as ┌N1×O1×N2×O2)·log₂(K1×K2)┐. In other words, the UCI amount may be reduced by bits corresponding to ┌log₂(K1×K2)┐.

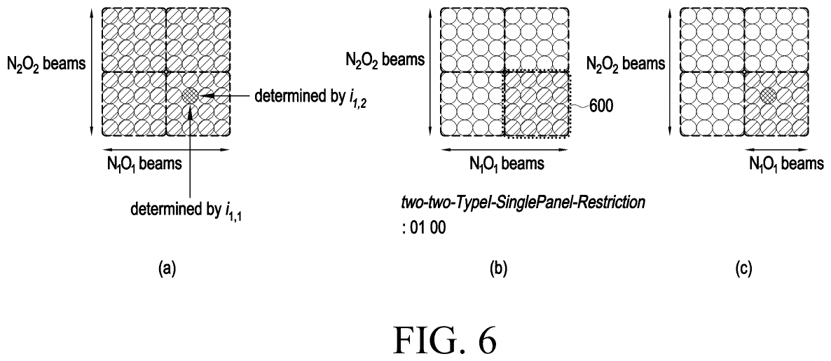

FIGS. 6 to 8 illustrate three embodiments in which a system is operated by applying those described with reference to (a) and (b) of FIG. 5.

FIG. 6 illustrates an example of a beam grid index fed back by beam grouping according to an embodiment of the present disclosure.

FIG. 6 is described assuming a system supporting N1=2, N2=2, O1=4, and O2=4. In (a), (b), and (c) of FIG. 6, it is shown that the beams indicated by the hatching are active, and the remaining beams are limited.

When beam grouping is not used as shown in (a) of FIG. 6, ┌log₂(N1×O1×N2×O2)┐=6 bits are required to report N1×O1=8 indices in the horizontal direction and N2×O2=8 indices in the vertical direction. Accordingly, in (b) of FIG. 6, the base station activates only one beam group 600 through two-two-TypeI-SinglePanel-Restriction, thereby changing to report four beams in the horizontal direction and four beams in the vertical direction as shown in (c) of FIG. 6, SO that feedback bits of ┌log₂(N1×O1×N2×O2)·log₂(K1×K2)┐=4 bits are required, and the UCI amount is reduced by 2 bits.

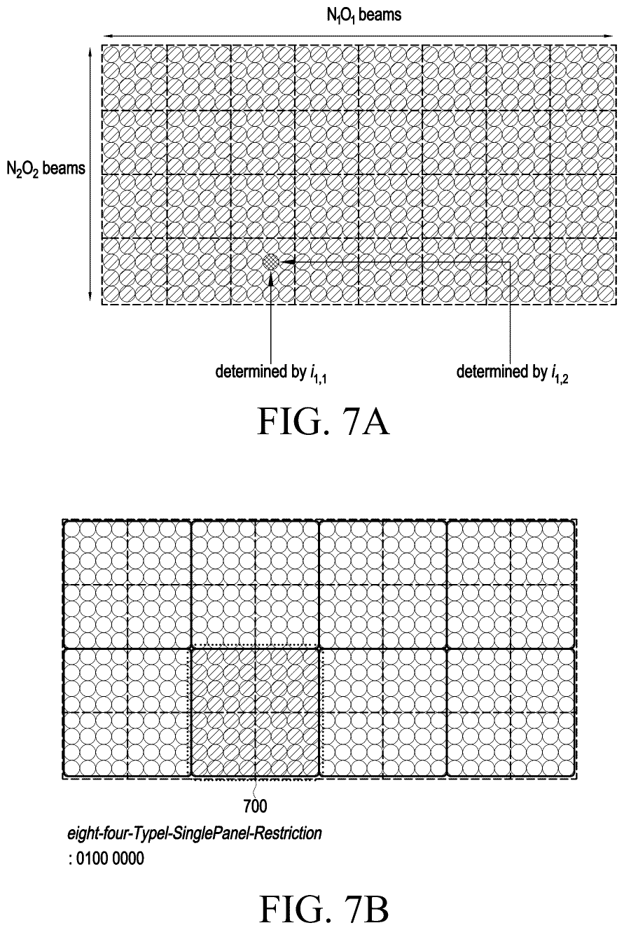

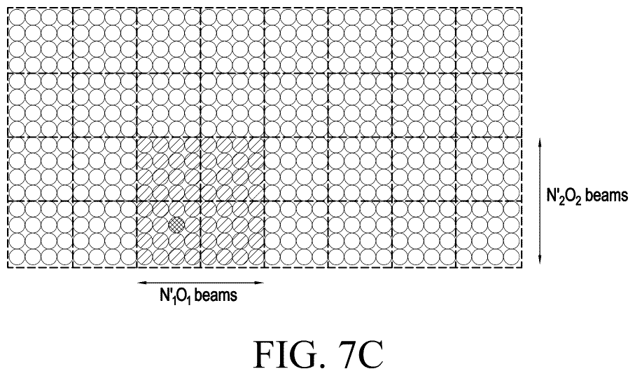

FIGS. 7A, 7B, and 7C illustrate an example of a beam grid index fed back for one beam group by beam grouping according to an embodiment of the present disclosure.

FIGS. 7A, 7B, and 7C are described assuming a system supporting N1=8, N2=4, O1=4, and O2=4. In FIGS. 7A, 7B, and 7C, it is shown that the beams indicated by the hatching are active, and the remaining beams are limited.

When beam grouping is not used as shown in FIG. 7A, ┌log₂(N1×O1×N2×O2)┐=9 bits are required to report the indices of N1×O1=32 in the horizontal direction and N2×O2=16 in the vertical direction.

However, as shown in FIG. 7B, it is possible to report eight beams in the horizontal direction and eight beams in the vertical direction by activating one beam group 700 through eight-four-TypeI-SinglePanel-Restriction. In this case, ┌log₂(N1×O1×N2×O2)·log₂(K1×K2)┐=6 bits feedback bits are required, and the UCI amount may be reduced by 3 bits.

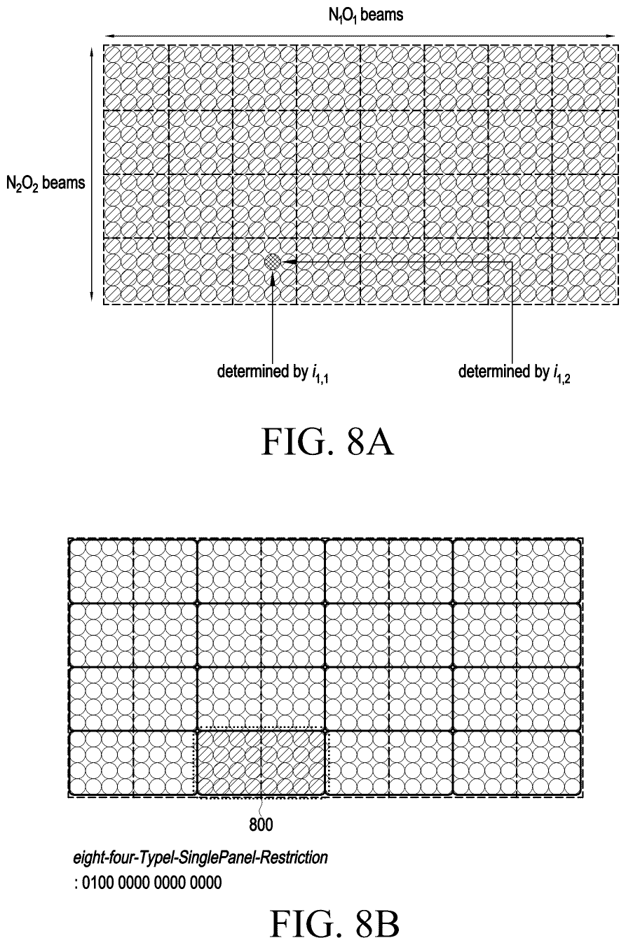

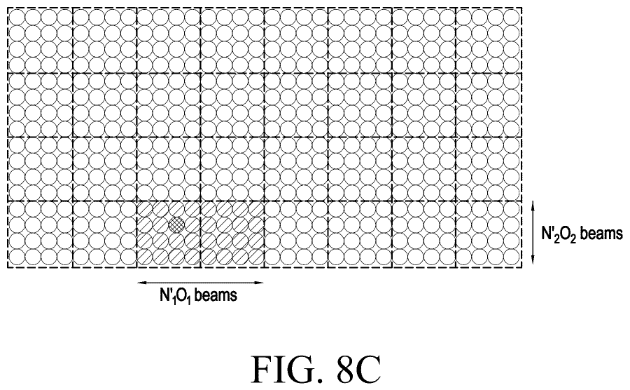

FIGS. 8A, 8B, and 8C illustrate an example of a beam grid index fed back for one beam group by beam grouping according to an embodiment of the present disclosure.

FIGS. 8A, 8B, and 8C are described assuming a system supporting N1=8, N2=4, O1=4, and O2=4. In FIGS. 8A, 8B, and 8C, it is shown that the beams indicated by the hatching are active, and the remaining beams are limited.

When beam grouping is not used as shown in FIG. 8A, if all the beams are active, ┌log₂(N1×O1×N2×O4)┐=9 bits are required to report the indices of N1×O1=32 in the horizontal direction and N2×O2=16 in the vertical direction.

However, as shown in FIG. 8B, the base station may specify to report eight beams in the horizontal direction and four beams in the vertical direction by activating one beam group 800 through eight-four-TypeI-SinglePanel-Restriction. In this case, ┌log₂(N1×O1×N2×O2)·log₂(K1×K2)┐=5 bits feedback bits are required, and the UCI amount may be reduced by 4 bits.

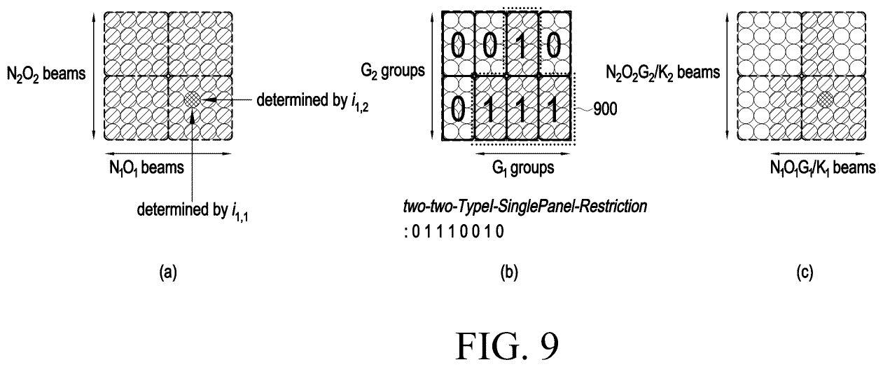

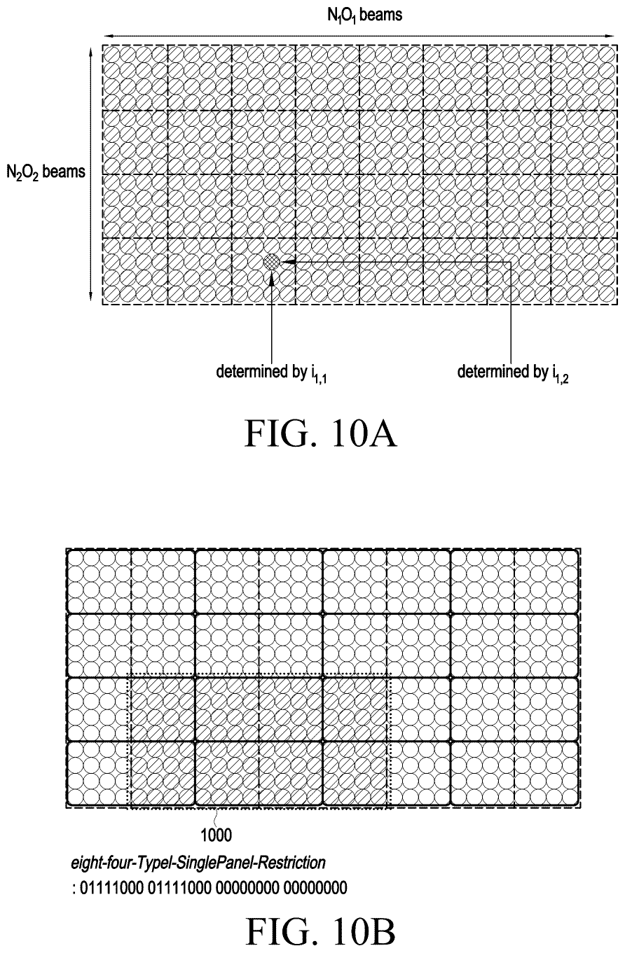

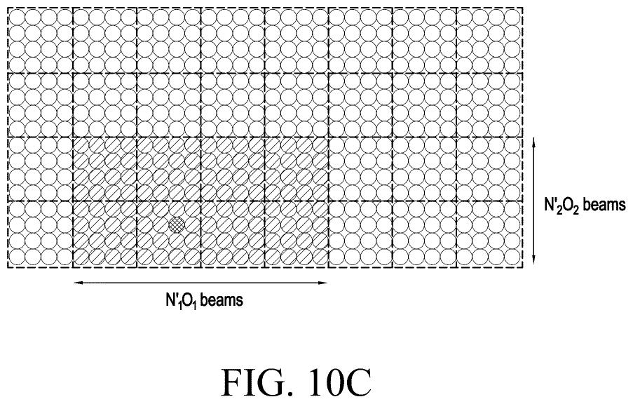

Secondly, in FIGS. 9 and 10, a UE reporting method for a case in which only a PMI matrix corresponding to two or more beam groups is used for system operation is described.

The base station may activate several beam groups through n1-n2-TypeI-SinglePanel-Restriction. As described above, when n1-GroupSize and n2-GroupSize are present in the fields, they are allowed to be allocated by group. Likewise, the number of feedback bits decreases according to the number of beam groups, but the number of indices to be expressed may increase according to the activated beams, and thus the number of feedback bits may increase. When the number of beam groups activated in the horizontal direction is G1 and the number of beam groups activated in the vertical direction is G2, the number of bits to be fed back by the UE is the same as ┌log₂(N1×O1×N2×O2)−log₂(K1×K2)+log₂(G1×G2)┐.

Two embodiments in which the system is operated by applying the above-described UE reporting method are separately described.

FIG. 9 illustrates an example of a beam grid index fed back for a plurality of beam groups by beam grouping according to an embodiment of the present disclosure.

FIG. 9 is described assuming a system supporting N1=2, N2=2, O1=4, and O2=4. In (a), (b), and (c) of FIG. 9, it is shown that the beams indicated by the hatching are active, and the remaining beams are limited.

When beam grouping is not used as shown in (a) of FIG. 9, ┌log₂(N1×O1×N2×O2)=6 bits are required to report N1×O1-8 indices in the horizontal direction and N2×O2=8 indices in the vertical direction. However, in FIG. 9(b), the base station activates several beam groups 900 through bits indicating the beam groups in the two-two-TypeI-SinglePanel-Restriction, and thus, as shown in FIG. 9(c), the UE may report six beams in the horizontal direction and eight beams in the vertical direction, i.e., three beam groups activated in the horizontal direction, and two beam groups activated in the vertical direction. In this case, as G1=3, G2=2, ┌log₂(N1×O1×N2×O2)−(K1×K2)+log₂(G1×G2)┐=6 bits of feedback bits are required when reporting. There is no change in the feedback bit, but search complexity decreases from the UE point of view.

FIGS. 10A, 10B, and 10C illustrate an example of a beam grid index fed back for a plurality of beam groups by beam grouping according to an embodiment of the present disclosure.

FIGS. 10A, 10B, and 10C are described assuming a system supporting N1=8, N2=4, O1=4, and O2=4. In FIGS. 10A, 10B, and 10C, it is shown that the beams indicated by the hatching are active, and the remaining beams are limited.

When beam grouping is not used as shown in FIG. 10A, ┌log₂(N1×O1×N2×O2)┐=9 bits are required to report the indices of N1×O1=32 in the horizontal direction and N2×O2=16 in the vertical direction.

However, in FIG. 10B, the base station may allow the UE to report 16 beams in the horizontal direction and 8 beams in the vertical direction, as shown in FIG. 10C, by activating several beam groups 1000 through eight-four-TypeI-SinglePanel-Restriction. In this case, when reporting, ┌log₂(N1×O1×N2×O2)−log₂(K1×K2)+log₂(G1×G2)┐=7 bits of feedback bits are required. The UCI amount is reduced by 2 bits, which reduces search complexity from the UE's perspective.

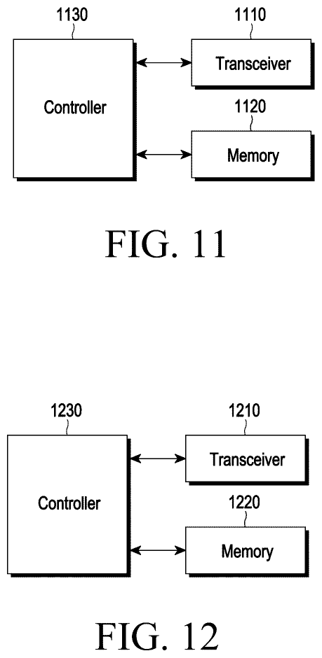

FIG. 11 illustrates a structure of a base station according to an embodiment of the present disclosure.

Referring to FIG. 11, a base station may include a transceiver 1110, a controller 1130, and memory 1120. However, the components of the base station are not limited to the above-described examples, and as an embodiment, the base station may include more or fewer components than the illustrated components. The transceiver 1110, the controller 1130, and the memory 1120 may be implemented in the form of a single chip.

The transceiver 1110 may transmit and receive signals to/from a base station. The signal may include control information and data. To that end, the transceiver 1110 may include a radio frequency (RF) transmitter for frequency-up converting and amplifying signals transmitted and an RF receiver for low-noise amplifying signals received and frequency-down converting the frequency of the received signals. However, this is merely an example of the transceiver 1110, and the components of the transceiver 1110 are not limited to the RF transmitter and the RF receiver. The transceiver 1110 may receive signals via a radio channel, output the signals to the controller 1130, and transmit signals output from the controller 1130 via a radio channel. The transceiver 1110 may separately include an RF transceiver for a first wireless communication technique and an RF transceiver for a second wireless communication technique or may perform physical layer processing according the first wireless communication technique and the second wireless communication technique using a single transceiver.

The memory 1120 may store programs and data necessary for the operation of the UE. The memory 1120 may store control information or data that is included in the signal transmitted/received by the UE. The memory 1120 may include a storage medium, such as ROM, RAM, hard disk, CD-ROM, and DVD, or a combination of storage media. There may be provided a plurality of memories 1120.

The controller 1130 may control a series of operations to allow the UE to operate according to the above-described embodiments. The controller 1130 may include at least one processor, and a series of processes that enable the UE to operate may be performed by each or a combination of at least one processor belonging to the controller.

The at least one processor may determine a number of beam groups in a first dimension and a number of beam groups in a second dimension for reporting at least one precoding matrix indicator (PMI)-related parameter for a plurality of two-dimensional beams. The at least one processor may control to transmit a RRC configuration message for reporting the at least one PMI-related parameter to a UE. In an embodiment, the RRC configuration message may include information about the number of beam groups in the first dimension and the number of beam groups in the second dimension.

The at least one processor may control to receive reporting of the PMI-related parameter based on the RRC configuration message from the UE. In an embodiment, a length of a feedback bit string related to the first dimension and the second dimension included in the reporting the PMI-related parameter may be based on the number of beam groups in the first dimension and the number of beam groups in the second dimension.

In an embodiment, the RRC configuration message may include an indicator indicating an activated beam group. In an embodiment, a length of the bit string of the indicator indicating the activated beam group may be based on the number of beam groups in the first dimension and the number of beam groups in the second dimension.

In an embodiment, the RRC configuration message may include a number of activated beam groups in the first dimension and a number of activated beam groups in the second dimension. In an embodiment, the length of the feedback bit string related to the first dimension and the second dimension included in the reporting of the PMI-related parameter may be based on the number of activated beam groups in the first dimension and the number of activated beam groups in the second dimension.

In an embodiment, the length of the feedback bit string included in the reporting of the PMI-related parameter may be shorter than or equal to a length of a feedback bit string related to the first dimension and the second dimension determined based on the plurality of two-dimensional beams. In an embodiment, the indicator indicating the activated beam group may be determined by at least one beam grid having a high PMI distribution according to at least one reported PMI-related parameter.

FIG. 12 illustrates a structure of a UE according to an embodiment of the present disclosure.

Referring to FIG. 12, a user equipment (UE) may include a transceiver 1210, a controller 1230, and memory 1220. However, the components of the UE are not limited to the above-described examples, and as an embodiment, the UE may include more or fewer components than the illustrated components. The transceiver 1210, the controller 1230, and the memory 1220 may be implemented in the form of a single chip.

The transceiver 1210 may transmit and receive signals to/from a base station. The signal may include control information and data. To that end, the transceiver 1210 may include a radio frequency (RF) transmitter for frequency-up converting and amplifying signals transmitted and an RF receiver for low-noise amplifying signals received and frequency-down converting the frequency of the received signals. However, this is merely an example of the transceiver 1210, and the components of the transceiver 1210 are not limited to the RF transmitter and the RF receiver. The transceiver 1210 may receive signals via a radio channel, output the signals to the controller 1230, and transmit signals output from the controller 1230 via a radio channel. The transceiver 1210 may separately include an RF transceiver for a first wireless communication technique and an RF transceiver for a second wireless communication technique or may perform physical layer processing according the first wireless communication technique and the second wireless communication technique using a single transceiver.

The memory 1220 may store programs and data necessary for the operation of the UE. The memory 1220 may store control information or data that is included in the signal transmitted/received by the UE. The memory 1220 may include a storage medium, such as ROM, RAM, hard disk, CD-ROM, and DVD, or a combination of storage media. There may be provided a plurality of memories 1220.

The controller 1230 may control a series of operations to allow the UE to operate according to the above-described embodiments. The controller 1230 may include at least one processor, and a series of processes that enable the UE to operate may be performed by each or a combination of at least one processor belonging to the controller.

The at least one processor may control receiving, from a base station, an RRC configuration message for reporting at least one precoding matrix indicator (PMI)-related parameter for a plurality of two-dimensional beams. In an embodiment, the RRC configuration message may include information about a number of beam groups in a first dimension and a number of beam groups in a second dimension.

The at least one processor may control to transmit, to the base station, reporting of the PMI-related parameter based on the RRC configuration message. In an embodiment, the length of the feedback bit string related to the first dimension and the second dimension included in the reporting of the PMI-related parameter may be based on the number of activated beam groups in the first dimension and the number of activated beam groups in the second dimension.

In an embodiment, the RRC configuration message may include an indicator indicating an activated beam group. In an embodiment, a length of the bit string of the indicator indicating the activated beam group may be based on the number of beam groups in the first dimension and the number of beam groups in the second dimension.

In an embodiment, the RRC configuration message may include a number of activated beam groups in the first dimension and a number of activated beam groups in the second dimension. In an embodiment, the length of the feedback bit string related to the first dimension and the second dimension included in the reporting of the PMI-related parameter may be based on the number of activated beam groups in the first dimension and the number of activated beam groups in the second dimension. In an embodiment, the length of the feedback bit string included in the reporting of the PMI-related parameter may be shorter than or equal to a length of a feedback bit string related to the first dimension and the second dimension determined based on the plurality of two-dimensional beams. In an embodiment, the indicator indicating the activated beam group may be determined by at least one beam grid having a high PMI distribution according to at least one reported PMI-related parameter.

The methods according to the embodiments described in the specification or claims of the disclosure may be implemented in hardware, software, or a combination of hardware and software. When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
determining a number of first dimensional beam groups and a number of second dimensional beam groups for reporting at least one precoding matrix indicator (PMI)-related parameter for a plurality of two-dimensional beams;
transmitting, to a user equipment (UE), a radio resource control (RRC) configuration message including information on the number of the first dimensional beam groups and the number of the second dimensional beam groups; and
receiving, from the UE, a report of the at least one PMI-related parameter based on the RRC configuration message,
wherein a length of a feedback bit string related to a first dimension and a second dimension included in the report of the at least one PMI-related parameter is determined based on the number of the first dimensional beam groups and the number of the second dimensional beam groups.

2. The method of claim 1, wherein the RRC configuration message includes an indicator indicating an activated beam group, and
wherein a length of a bit string of the indicator is determined based on the number of the first dimensional beam groups and the number of the second dimensional beam groups.

3. The method of claim 1, wherein the RRC configuration message includes information on a number of first dimensional activated beam groups and a number of second dimensional activated beam groups, and
wherein the length of the feedback bit string is determined based on the number of the first dimensional activated beam groups and the number of the second dimensional activated beam groups.

4. The method of claim 2, wherein the length of the feedback bit string is shorter than or equal to a length of a feedback bit string related to the first dimension and the second dimension determined based on the plurality of two-dimensional beams.

5. The method of claim 2, wherein the indicator is determined by at least one beam grid having a relatively high PMI distribution according to the at least one PMI-related parameter which is reported by the UE.

6. A method by a UE in a wireless communication system, the method comprising:
receiving, from a base station, a radio resource control (RRC) configuration message including information on a number of first dimensional beam groups and a number of second dimensional beam groups; and
transmitting, to the base station, a report of at least one precoding matrix indicator (PMI)-related parameter for a plurality of two-dimensional beams based on the RRC configuration message,
wherein a length of a feedback bit string related to a first dimension and a second dimension included in the report of the at least one PMI-related parameter is determined based on the number of the first dimensional beam groups and the number of the second dimensional beam groups.

7. The method of claim 6, wherein the RRC configuration message includes an indicator indicating an activated beam group, and
wherein a length of a bit string of the indicator is determined based on the number of the first dimensional beam groups and the number of the second dimensional beam groups.

8. The method of claim 6, wherein the RRC configuration message includes information on a number of first dimensional activated beam groups and a number of second dimensional activated beam groups, and
wherein the length of the feedback bit string is determined based on the number of the first dimensional activated beam groups and the number of the second dimensional activated beam groups.

9. The method of claim 7, wherein the length of the feedback bit string is shorter than or equal to a length of a feedback bit string related to the first dimension and the second dimension determined based on the plurality of two-dimensional beams.

10. The method of claim 7, wherein the indicator is determined by at least one beam grid having a relatively high PMI distribution according to the at least one PMI-related parameter which is reported by the UE.

11. A base station in a wireless communication system, the base station comprising:
a transceiver; and
at least one processor, wherein the at least one processor is configured to:
determine a number of first dimensional beam groups and a number of second dimensional beam groups for reporting at least one precoding matrix indicator (PMI)-related parameter for a plurality of two-dimensional beams,
transmit, to a user equipment (UE), a radio resource control (RRC) configuration message including information on the number of the first dimensional beam groups and the number of the second dimensional beam groups, and
receive, from the UE, a report of the at least one PMI-related parameter based on the RRC configuration message,
wherein a length of a feedback bit string related to a first dimension and a second dimension included in the report of the at least one PMI-related parameter is determined based on the number of the first dimensional beam groups and the number of the second dimensional beam groups.

12. The base station of claim 11, wherein the RRC configuration message includes an indicator indicating an activated beam group, and
wherein a length of a bit string of the indicator is determined based on the number of the first dimensional beam groups and the number of the second dimensional beam groups.

13. The base station of claim 11, wherein the RRC configuration message includes information on a number of first dimensional activated beam groups and a number of second dimensional activated beam groups, and
wherein the length of the feedback bit string is determined based on the number of the first dimensional activated beam groups and the number of the second dimensional activated beam groups.

14. The base station of claim 12, wherein the length of the feedback bit string is shorter than or equal to a length of a feedback bit string related to the first dimension and the second dimension determined based on the plurality of two-dimensional beams.

15. The base station of claim 12, wherein the indicator is determined by at least one beam grid having a relatively high PMI distribution according to the at least one PMI-related parameter which is reported to the UE.

16. A UE in a wireless communication system, the UE comprising:
a transceiver; and
at least one processor, wherein the at least one processor is configured to:
receive, from a base station, a radio resource control (RRC) configuration message including information on a number of first dimensional beam groups and a number of second dimensional beam groups, and
transmit, to the base station, a report of at least one precoding matrix indicator (PMI)-related parameter for a plurality of two-dimensional beams based on the RRC configuration message,
wherein a length of a feedback bit string related to a first dimension and a second dimension included in the report of the at least one PMI-related parameter is determined based on the number of the first dimensional beam groups and the number of the second dimensional beam groups.

17. The UE of claim 16, wherein the RRC configuration message includes an indicator indicating an activated beam group, and
wherein a length of a bit string of the indicator is determined based on the number of the first dimensional beam groups and the number of the second dimensional beam groups.

18. The UE of claim 16, wherein the RRC configuration message includes information on a number of first dimensional activated beam groups and a number of second dimensional activated beam groups, and
wherein the length of the feedback bit string is determined based on the number of the first dimensional activated beam groups and the number of the second dimensional activated beam groups.

19. The UE of claim 17, wherein the length of the feedback bit string is shorter than or equal to a length of a feedback bit string related to the first dimension and the second dimension determined based on the plurality of two-dimensional beams.

20. The UE of claim 17, wherein the indicator is determined by at least one beam grid having a relatively high PMI distribution according to the at least one PMI-related parameter which is reported to the UE.
